(19) United States
(12) Patent Application Publication
(10) Pub. No.: US 2008/0265614 A1
(43) Pub. Date: Oct. 30, 2008

(54) Vehicle Door Module

(75) Inventors: Alexander Schidan, Solingen (DE); Hans-Helmut Mieglitz, Monheim am Rhein (DE); Burkhard Corves, Eynatten-Lichtenbusch (BE); Mathias Husing, Aachen (DE); Peter Markert, Stolberg (DE); Mohannad Tarsha Kordi, Aachen (DE); Martin Riedel, Aachen (DE)

Correspondence Address: FOLEY AND LARDNER LLP;SUITE 500, 3000 K STREET NW, WASHINGTON, DC, 20007, US

(73) Assignee: Johnson Controls Interiors GmbH & Co. KG, Grefrath (DE)

(21) Appl. No.: 11/596,752

(22) PCT Filed: Apr. 28, 2005
(86) PCT No.: PCT/EP2005/051931

§ 371 Date: Jun. 10, 2008

(30) Foreign Application Priority Data
May 28, 2004 (DE) 10 2004 026 680.8

(51) Int. Cl. B60J 5/00

(52) U.S. Cl. 296/146.2

(57) ABSTRACT

A vehicle door module comprises a drive shaft for displacing a displacement device, particularly a window lifter. The vehicle door module and the displacement device can be assembled together in any particular position of rotation of the drive shaft.

### CROSS-REFERENCE TO RELATED PATENT APPLICATIONS

The present Application claims the benefit of priority to the following International Application: PCT Patent Application No. PCT/EP2005/051931 titled “Vehicle Module, Particularly a Door Module, Comprising a Drive Shaft for Displacing a Displacement Device, Particularly a Window Lifter, Vehicle Component, Particularly a Vehicle Door, and Method for Assembling a Vehicle Component” filed on Apr. 28, 2005, which claims priority to German Patent Application No. DE 102004026680.8 filed May 28, 2004 (which are both incorporated herein by reference in their entirety).

### FIELD

The invention relates to a vehicle module, particularly a door module, comprising a drive shaft for displacing a displacement device, particularly a window lifter.

### BACKGROUND

It is generally known to equip vehicles, particularly motor vehicles, with displaceable elements, such as for example electric window lifters, electric sliding roofs, electrically displaceable seats, electrically displaceable steering columns and the like. Particularly with motor vehicle doors which, when considered in isolation, already comprise a plurality of displacement units to be electrically actuated, it is generally known to provide such a motor vehicle door in a wet space and a dry space for the purpose of improved distribution of components and for reducing costs. In this connection, it may be necessary for a drive for a displacement element to be arranged on the dry side of the vehicle door and for the displacement element itself, i.e. the substantial part of the mechanics of the displacement element, to be arranged on the wet side of the vehicle component and/or the vehicle door. During assembly of the vehicle component it is, therefore, necessary to connect the elements of the dry side to the elements of the wet side, a mechanical drive clutch being, therefore, necessary if the drive is arranged on the one side of the separation (between the wet and dry regions) and the adjusting device to be driven is arranged on the other side of the separation. If, for example, in this connection, a rotationally fixed connection is provided by means of a square shaft or the like, an assembly of the vehicle component is only possible in specific rotational positions of the drive shaft. This increases the cost of the assembly for the production of the vehicle component, as for example if a rotation of a vehicle module or the displacement device is necessary in order to bring the elements to be paired with one another into the correct position of rotation. This complicates the assembly of the vehicle component, in particular with blind assembly and/or with robot assisted assembly.

One object of the invention is, therefore, to alleviate the known drawbacks of the prior art and to provide a simple, robust, lightweight, vehicle component and/or a corresponding vehicle module which may be inexpensively produced and inexpensively assembled.

### SUMMARY

This object is achieved according to the invention by a vehicle module, particularly a door module, with a drive shaft for the displacement of a displacement device, particularly a window lifter, the vehicle module and the displacement device being able to be assembled together in any particular position of rotation of the drive shaft. This has the advantage that the vehicle module may be assembled with the displacement device considerably more simply, more easily and more consistently. It is, therefore, possible during final assembly of the individual components on the assembly line to manage with movement sequences which are few in number and easy to carry out. Furthermore, it is possible to manage with movement sequences which are suitable for robots. Furthermore, an important point is that the time for installing and/or for assembling the vehicle module with the displacement device for assembling a vehicle component is, on average, able to be reduced with the vehicle module according to the invention so that, on the one hand, working time is saved and, on the other hand, even with a continually moving production assembly line, space is saved during the assembly of the vehicle component.

It is preferred that the displacement device comprises a rotary element, particularly a drum, the drive shaft being able to be rotationally fixedly connected to the rotary element in at least one position of rotation. As a result, according to the invention a rotationally fixed connection between the drive shaft and the rotary element does not necessarily already have to be established during assembly, i.e. during the assembly process, but the rotationally fixed connection is only established later, for example after a rotation of the drive shaft by a specific angle.

Furthermore, in a first alternative it is preferred that the drive shaft comprises at least one locking element, the locking element rotationally fixedly connecting said drive shaft to the rotary element in at least one position of rotation of the drive shaft, the rotary element comprising at least one recess for receiving at least one part of the locking element, and/or it is preferred in a second alternative that the rotary element comprises at least one locking element, the locking element connecting said rotary element to the drive shaft in at least one position of rotation of the rotary element, the drive shaft comprising at least one recess for receiving at least one part of the locking element. In this manner, it is advantageously possible according to the invention to ensure a rotationally fixed connection between the rotary element and the drive shaft in both rotational directions, which is stable and permanently capable of load bearing.

It is further preferred that the at least one locking element is spring-loaded relative to the drive shaft (first alternative) or relative to the rotary element (second alternative). As a result, it is possible according to the invention that the drive shaft is locked and/or rotationally fixedly connected to the rotary element, as soon as the angular position of the drive shaft is set relative to the rotary element.

It is further preferred that after the assembly of the vehicle module and the displacement device and until the rotationally fixed connection between the drive shaft and the rotary element, a rotation of the drive shaft is possible relative to the rotary element, by a maximum of approximately 180°, particularly by a maximum of approximately 120°. As a result, it is firstly possible that the number of the required movable parts is kept relatively low and yet the region of “non-load rotation” is kept relatively small, until the rotationally fixed connection between the rotary element and the drive shaft.

A further subject of the present invention is a vehicle component, particularly a vehicle door, with a displacement device and with a vehicle module according to the invention. The facilitation of assembly which may be implemented according to the invention for the vehicle module and the displacement device, is naturally also passed onto the vehicle component, as said vehicle component is also robust, lightweight, and may be produced inexpensively and assembled inexpensively.

A further subject of the present invention is a method for assembling a vehicle component, particularly a vehicle door, a vehicle module, comprising a drive shaft for the displacement of a displacement device, being assembled with the displacement device, the vehicle module and the displacement device being assembled irrespective of the position of rotation of the drive shaft. The method may, therefore, be particularly simple and inexpensive to implement, so that said method is also particularly suitable for automation but also has the desired advantages of simplicity and rapidity, when implemented manually (blind assembly).

It is further preferred that, after assembly, the drive shaft is rotated relative to a rotary element of the displacement device, before a rotationally fixed connection is established between the drive shaft and the rotary element. Such a rotation brings considerable advantages to the assembly process and/or to the method according to the invention and represents virtually no drawbacks due to the fact that the rotationally fixed connection is not initially present, as with regard to the service life of the vehicle component and/or the vehicle module, it is not relevant whether a rotation of the drive shaft by a maximum of 360° is additionally carried out or not.

### BRIEF DESCRIPTION OF THE FIGURES

The invention is described in more detail hereinafter with reference to embodiments shown in the drawings, in which:

FIG. 1 shows a principal section through a vehicle door as an example of a vehicle component according to one embodiment of the invention,

FIG. 2 shows the principle of a coupling possibility between a drive shaft and a rotary element,

FIG. 3 shows the moment of the engagement of the drive shaft in the rotary element,

FIG. 4 shows a vehicle module assembled with the displacement device and

FIG. 5 shows the section along the line of intersection I-I of FIG. 4.

### DETAILED DESCRIPTION

During the final assembly of vehicles, particularly of motor vehicles, the assembly steps are intended to be carried out as rapidly and easily as possible on the assembly line and as many pre-assembled components and/or modules as possible are intended to be assembled. In this connection, the movement sequences, which may be carried out by operators or robots for putting together the components and/or modules, also have to be carried out as easily and rapidly as possible. This is firstly necessary for the assembly itself, but also for the logistics, such as for example the just-in-time supply, the time reduction on the assembly line and/or the suitability for robot assembly.

In the example of a vehicle door as a vehicle component, for example all modules of this vehicle door should be preferably mounted in a so-called Y position, i.e. for example the internal door trim is most advantageously displaced in a position which is aligned parallel to the structure and connected thereto during this movement. If different parts of the vehicle component and/or in the example of the vehicle door, parts of a drive train, have to be assembled for displacing a displacement device, for example of window lifters, the assembly of such a displacement device with a motor unit also has to be adapted to the requirements which have to be taken into account during assembly. In this connection, care has to be taken over the component part tolerances.

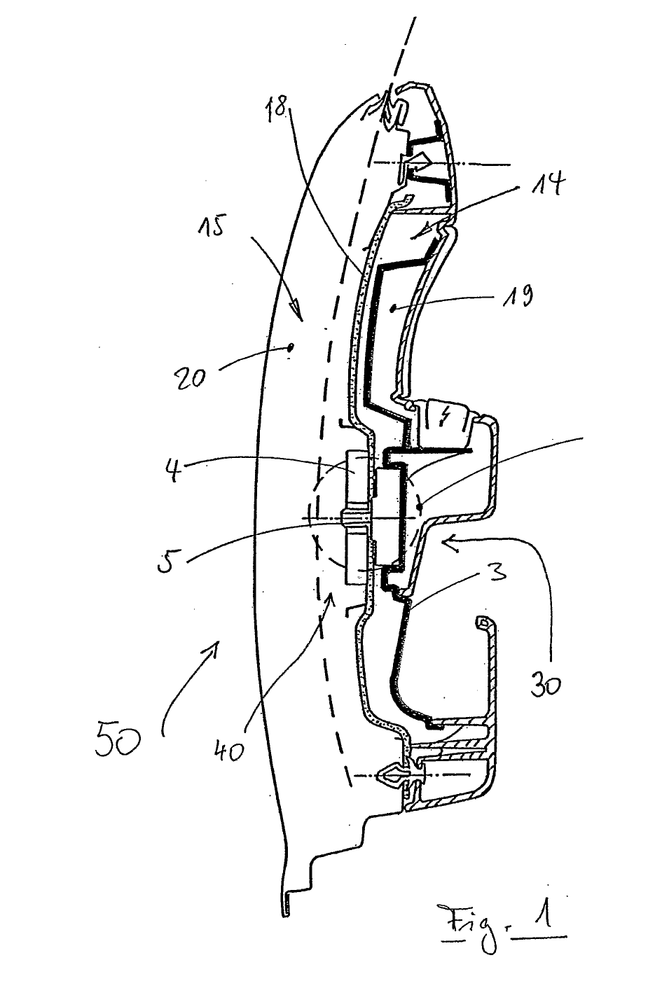

FIG. 1 shows a principal section through a vehicle door as an example of a vehicle component 50. The exemplary construction of the door is shown, which is divided into a so-called wet space 15 and a dry space 14. At the exemplary interface and/or separation formed, for example, by a separating film 18 between the wet space 15 and dry space 14, the coupling area of the window lifter mechanism provided, for example, for a displacement device 40, and a vehicle module 30, which for example comprises the drive motor of the window lifter mechanism, is shown by a detail 17. The vehicle module 30 is, therefore, associated in the example shown with the dry space 14 and the displacement device 40 is associated with the wet space 15: The invention is, however, not restricted to this association, but the association could also be reversed. However, hereinafter it is assumed that the vehicle module 30 is associated with the dry space 14 and the displacement device is associated with the wet space 15.

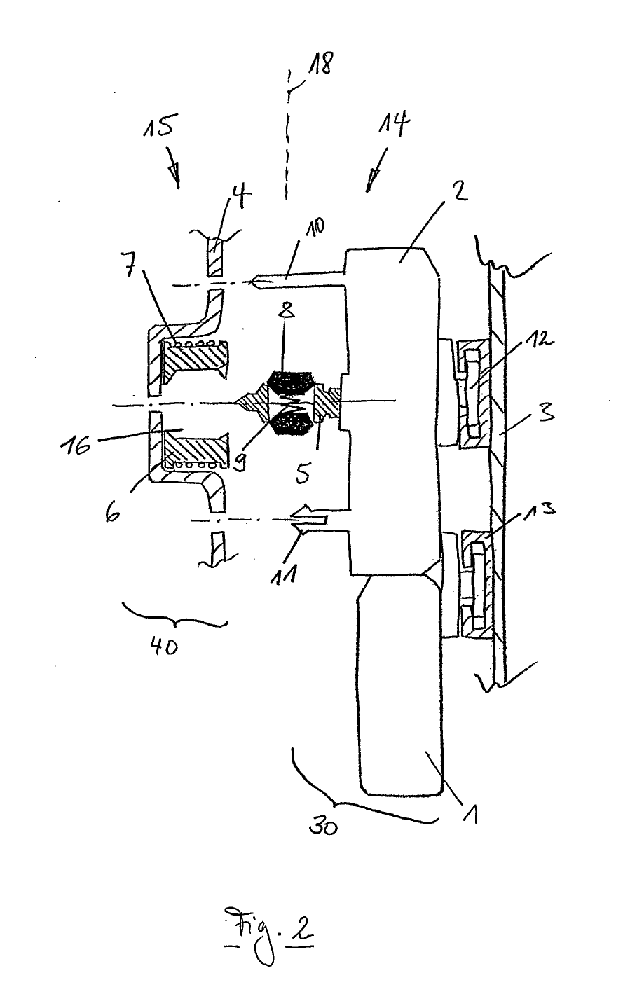

The further FIGS. 2 to 5 substantially refer only to this detail 17. In FIG. 1, moreover, further parts of the vehicle door and/or the vehicle component 50 are shown by way of example, particularly a Bowden cable housing 4 as a part of the window lifter mechanism, a drive shaft 5 as a part of the vehicle module 30, a trim module 19, which particularly at the time of the final assembly is already connected to the vehicle module 30 and a bodywork module 20, which as regards the present invention, forms part of the displacement device 40 and, in particular, provides the necessary mechanical stability to the vehicle component 50.

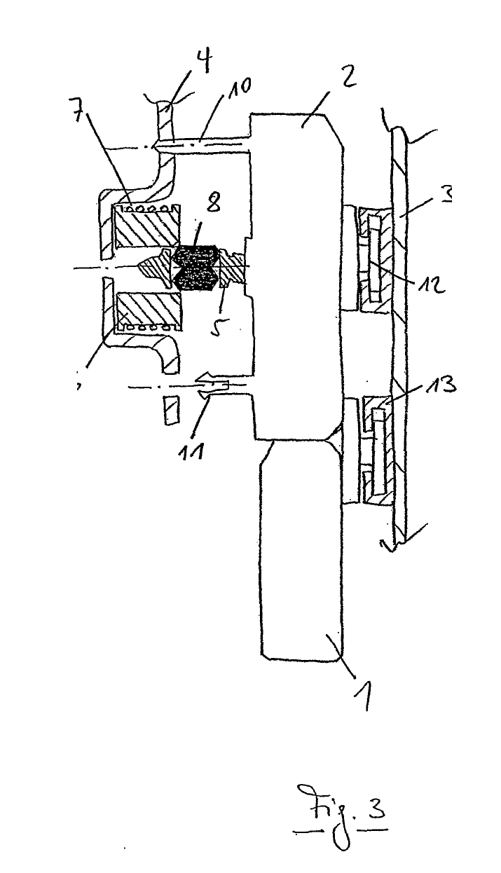

In FIG. 2 the principle of a coupling possibility between the drive shaft 5 and a rotary element 6 is shown, the rotary element 6 corresponding in the example to a cable drum 6, which causes, by means of its rotation, movement of the window, for example. The wet space 15 and the dry space 14 which are separated by the separating film and/or separating layer 18 may be seen, only the separating layer 18 being indicated, however. It may also be seen that the drive shaft 5, a drive motor 1, a gear mechanism 2, a centering journal 12 and/or a centering cage 13 for the floating fastening of the door trim support 3 and a centering pin 10 and snap-in element 11 are parts of the vehicle module 30, which have to be connected to the displacement device 40 during the final assembly of the vehicle component. On the side of the displacement device 40, in addition to the rotary element 6, the Bowden cable housing 4 and a cable 7 wound onto the cable drum 6 and/or the rotary element 6, for example, may be seen. During the assembly of the vehicle module 30 and the displacement device 40, on the one hand, the mechanical stability is produced by mechanical fastening elements, such as for example the centering pin 10 and the snap-in element 11. For implementing the drive coupling between the drive shaft 5 and the rotary element 6 in the example shown, the drive shaft 5 is firstly introduced into the rotary element 6. In this connection, locking elements 8 which may be spring-loaded by means of a spring 9 and which are provided on the drive shaft 5, engage in a groove 16 on the rotary element 6. This is described in more detail in FIGS. 3 to 5. Naturally, it may also be provided that the rotary element 6 is inserted into a recess of the drive shaft 5. However, the following description refers, for example, only to the embodiment shown in FIGS. 3 to 5.

It may also be seen in FIG. 2 that the pre-assembled vehicle module 30 comprises the drive elements such as the motor 1, the gear mechanism 2, together with the drive shaft 5 in a so-called floating bearing on the door trim and/or the door trim support 3. In this connection, inaccuracies of the bodywork module 20 relative to the trim module 19 (see respectively FIG. 1) may be compensated by the centering cages 13 and/or the centering journals 12. The centering cages 13 and the centering journals 12 are also hereinafter denoted together as centering means. The tolerance compensation is carried out when the drive shaft 5 is assembled in the rotary element 6, this process also being denoted as meshing as, in this connection, beveled edges of the drive shaft 5 ensure a secure insertion of the drive shaft 5 into the rotary element 6. In this assembly situation, the fastening means (centering pin 10 and/or snap-in element 11) already cause the drive elements to be sufficiently rigidly locked in position and/or fixed.

One essential part of the mechanical rotationally fixed coupling between the drive shaft 5 and the rotary element 6 is effected by the locking elements 8 arranged in the shaft core of the drive shaft 5 and which are also denoted hereinafter as locking bars 8. According to one embodiment of the invention, these locking elements 8 are, in particular, spring-mounted and serve as drive elements between the drive shaft 5 and the rotary element 6.

The drive shaft 5 and the rotary element 6 are shown in FIG. 3 at the time of the initial assembly of the vehicle module 30 with the displacement device 40. The locking elements 8 are compressed by the diameter of the rotary element 6 (outside the groove 16), entering the core region of the shaft 5. The centering and/or the guidance during the assembly of the vehicle module 30 with the displacement device 40 is assisted by leading alignment pins 10 and/or pins provided for fixing as snap-in elements 11. As it is highly unlikely that the locking bar 8, in the assembly step and during any position of rotation of the drive shaft 5, precisely coincides with the groove 16 shown in FIG. 2 (and not shown in FIG. 3) of the rotary element 6, the locking bar 8 only engages in the groove 16 when the drive shaft 5 is rotated. With the use of just one locking bar 8 and/or one locking element 8 and just one groove 16, the non-loaded rotation, i.e. the rotation of the drive shaft 5 without being rotationally fixedly connected to the rotary element 6, is for example one revolution, i.e. a rotation of 360°, and with a correspondingly higher number of locking bars 8 and/or grooves 16, the non-loaded rotation is naturally correspondingly less, for example with three grooves and/or locking bars 8 (which are also still evenly distributed) approximately 120°.

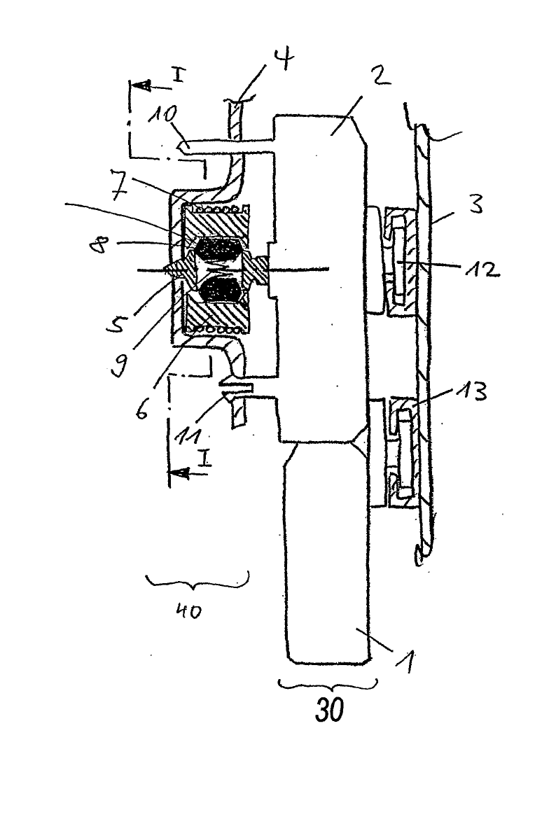

The vehicle module 30 is shown in FIG. 4, assembled with the displacement device 40, at least that which relates to the detail illustrated in FIG. 1 with the reference numeral 17. The locking bars 8 are engaged in the groove 16. It may also be seen that the vehicle module 30 and the adjustment device 40 are fixed by the centering pin 10 and/or the snap-in element 11. These centering pins and/or snap-in elements 10, 111 undertake in the load case i.e. during a movement of the window, the transmission of the transverse forces into the bodywork and, in the assembled state of the vehicle module 30, ensure the final position relative to the adjustment device 40.

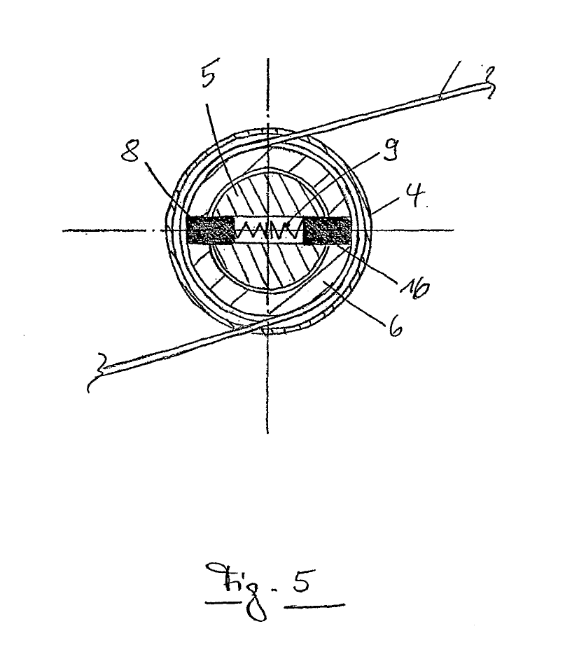

In FIG. 5 a sectional view is shown by way of example along a line of intersection I-I illustrated in FIG. 4, for example two locking bars 8 being engaged with two grooves 16. The grooves 16 are also denoted hereinafter as recesses 16. In principle, it is naturally possible both for the locking bars 8 to be provided on the drive shaft 5 and also for the recesses 16 to be provided on the rotary element 6, as is also shown in FIGS. 2 to 5. However, it is also possible in principle that the locking bars 8 are attached to the rotary element 6 and that the recesses 16 are provided on the drive shaft 5. According to various embodiments of the invention, combinations of both variants are naturally also conceivable.

A compression spring 9, shown by way of example in the Figures, may itself naturally also be a component of the locking bar 8, for example as a plastics injection-molded component. The number of locking bars 8 and grooves 16 and/or recesses 16 is naturally variable. For easier coupling of the drive shaft 5 to the rotary element 6, the number of locking bars 8 and grooves 16 should be smaller, but a larger number has a more favorable effect on the operation characteristics.

1. A vehicle module, comprising: a drive shaft and a displacement device wherein the vehicle module and the displacement device may be assembled together in any particular position of rotation of the drive shaft.

2. The vehicle module as claimed in claim 1, wherein the displacement device comprises a rotary element, the drive shaft being able to be rotationally fixedly connected to the rotary element in at least one position of rotation.

3. The vehicle module as claimed in claim 1, wherein the drive shaft comprises at least one locking element, the locking element rotationally fixedly connecting said drive shaft to the rotary element in at least one position of rotation of the drive shaft, the rotary element comprising at least one recess for receiving at least one part of the locking element.

4. The vehicle module as claimed in claim 3, wherein the at least one locking element is spring-loaded relative to at least one of the drive shaft and the rotary element.

5. The vehicle module as claimed in claim 3, wherein after the assembly of the vehicle module and the displacement device and until the rotationally fixed connection between the drive shaft and the rotary element, a rotation of the drive shaft is possible relative to the rotary element, by a maximum of approximately 180°.

6. The vehicle module as claimed in claim 1, further comprising centering means for the floating bearing of drive elements.

7. The vehicle module as claimed in claim 1, wherein the vehicle module is for a vehicle door.

8. The vehicle module as claimed in claim 7, wherein the displacement device is associated with one of a dry space and a wet space and the vehicle module is associated with the other of the dry space and the wet space.

9. The vehicle module as claimed in claim 7, wherein the displacement device comprises a cable drum, a Bowden cable and window lifter rails and the vehicle module comprises drive elements, including at least one of a drive motor and a gear mechanism.

10. A method for assembling a vehicle component, comprising: assembling a vehicle module and a displacement device, the vehicle module comprising a drive shaft for the displacement of the displacement device wherein the vehicle module and the displacement device are assembled irrespective of the position of rotation of the drive shaft.

11. The method as claimed in claim 10, wherein after assembly, the drive shaft is rotated relative to a rotary element of the displacement device before a rotationally fixed connection is established between the drive shaft and the rotary element.

12. The vehicle module of claim 1, wherein the displacement device is a window lifter for a vehicle door.

13. The vehicle module of claim 1, wherein the rotary element comprises at least one locking element, the locking element connecting the rotary element to the drive shaft in at least one position of rotation of the rotary element, the drive shaft comprising at least one recess for receiving at least one part of the locking element.

14. The vehicle module of claim 2, wherein the rotary element is a drum.

15. The vehicle module of claim 5, wherein the maximum rotation is approximately 120°.

16. The vehicle module of claim 6, wherein the drive elements include at least one of a drive motor and a gear mechanism.

17. A vehicle door, comprising:
a drive mechanism; and
a displacement device;
wherein the drive mechanism is rotationally fixed relative to the displacement device only when the drive mechanism is positioned at a predetermined position relative to the displacement device; and
wherein the drive mechanism may rotate within the displacement device when the drive mechanism is not positioned at the predetermined position.

18. The vehicle door of claim 17, wherein the drive mechanism is rotationally fixed relative to the displacement device at the predetermined position via a spring-loaded locking mechanism.

19. The vehicle door of claim 17, wherein the drive mechanism includes a drive shaft and the displacement device includes a rotatable drum.

20. The vehicle door of claim 17, further comprising:
a door support member;
wherein the drive mechanism is coupled to the door support member via centering means.
